(19) United States
(12) Patent Application Publication
(10) Pub. No.: US 2022/0307619 A1
(43) Pub. Date: Sep. 29, 2022

(54) AUTONOMOUS SENSOR CLEANING SOLENOID

(71) Applicants: Ford Global Technologies, LLC, Dearborn, MI (US); Valeo North America, Inc., Auburn Hills, MI (US)

(72) Inventors: Segundo Baldovino, Novi, MI (US); Venkatesh Krishnan, Canton, MI (US); Ashwin Arunmozhi, Canton, MI (US); Charles Prain, Auburn Hills, MI (US); Michael Whitney, Auburn Hills, MI (US); William S. Smith, Auburn Hills, MI (US); Theophile Jullien, Auburn Hills, MI (US); Denis Thebault, Auburn Hills, MI (US); Jean Baptiste Lahilaire, Auburn Hills, MI (US)

(73) Assignees: Ford Global Technologies, LLC, Dearborn, MI (US); Valeo North America, Inc., Auburn Hills, MI (US)

(21) Appl. No.: 17/209,375

(22) Filed: Mar. 23, 2021

(51) Int. Cl. F16K 31/06; B60S 1/66; G01D 5/14

(52) U.S. Cl. CPC F16K 31/0651; B60S 1/66; G01D 5/145

(57) ABSTRACT

An assembly includes an inlet tube and an outlet tube. The assembly includes a solenoid assembly having a plunger movable between an open position in which fluid is permitted to flow from the inlet tube to the outlet tube and a closed position in which fluid is inhibited from flowing from the inlet tube to the outlet tube, the solenoid assembly having an induction coil surrounding the plunger. The assembly includes a Hall effect sensor that detects a magnetic field of the solenoid assembly. The assembly includes a computer in communication with the Hall effect sensor, the computer having a processor and memory that stores instructions executable by the processor to identify a resistance of the induction coil based on data from the Hall effect sensor, and to determine whether the plunger is at the closed position based on the identified resistance of the induction coil.

### BACKGROUND

Vehicles, such as autonomous or semi-autonomous vehicles, typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. Some sensors are communications devices, for example, vehicle-to-infrastructure (V2I) or vehicle-to-vehicle (V2V) devices. Sensor operation can be affected by obstructions, e.g., dust, snow, insects, etc.

### BRIEF DESCRIPTION OF THE DRAWINGS

FIG. 1 is a perspective view of a vehicle having an assembly that controls cleaning fluid for sensors of the vehicle.

FIG. 2 is a side view of components of the assembly.

FIG. 3 is a cross section of components of the assembly in a closed position and taken along a line 3-3 of FIG. 2.

FIG. 4 is a cross section of components of the assembly in an open position and taken along the line 3-3.

FIG. 5 is a block diagram of components of the vehicle and the assembly.

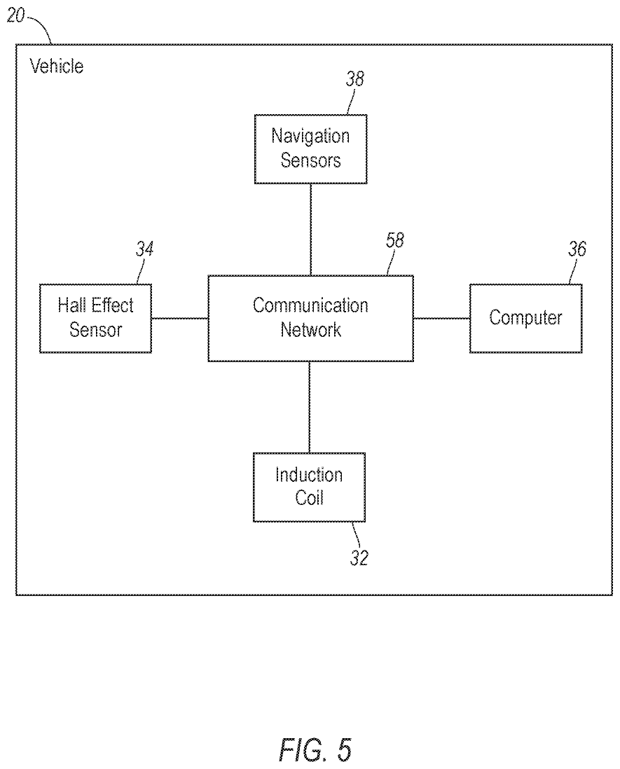

### DETAILED DESCRIPTION

An assembly includes an inlet tube and an outlet tube. The assembly includes a solenoid assembly having a plunger movable between an open position in which fluid is permitted to flow from the inlet tube to the outlet tube and a closed position in which fluid is inhibited from flowing from the inlet tube to the outlet tube, the solenoid assembly having an induction coil surrounding the plunger. The assembly includes a hall effect sensor that detects a magnetic field of the solenoid assembly. The assembly includes a computer in communication with the hall effect sensor, the computer having a processor and memory that stores instructions executable by the processor to identify a resistance of the induction coil based on data from the hall effect sensor, and to determine whether the plunger is at the closed position based on the identified resistance of the induction coil.

The instructions may include instructions to identify the resistance of the induction coil based on a current detected by the hall effect sensor.

The assembly may include a fluid reservoir fluidly connected with the inlet tube.

The assembly may include a nozzle fluidly connected with the outlet tube.

The assembly may include a camera, the nozzle facing the camera.

The plunger may be movable along an axis, and the plunger is between the hall effect sensor and the outlet tube along the axis.

The assembly may include a valve seat between the plunger and the outlet tube.

The plunger in the closed position may abut the valve seat.

The instructions may include instructions to store a diagnostic code in memory in response to determining the plunger is not at the closed position.

The solenoid assembly may include a spring urging the plunger toward the closed position.

The plunger may be closer to the hall effect sensor in the open position than in the closed position.

An assembly includes a solenoid assembly having a plunger movable along an axis between a first position and a second position, the solenoid assembly having an induction coil surrounding the plunger. The assembly includes a hall effect sensor that detects a magnetic field of the solenoid assembly. The assembly includes a computer in communication with the hall effect sensor and having a processor and memory that stores instructions executable by the processor to identify a resistance of the induction coil based on data from the hall effect sensor, and to determine whether the plunger is at the second position based on the magnetic field detected by the hall effect sensor and the identified resistance of the induction coil.

The instructions may include instructions to identify the resistance of the induction coil based on a current detected by the hall effect sensor.

The instructions may include instructions to store a diagnostic code in memory in response to determining the plunger is not at the second position.

The solenoid assembly may include a spring urging the plunger toward the closed position.

The plunger may be closer to the hall effect sensor in the open position than in the closed position.

With reference to the Figures, wherein like numerals indicate like parts throughout the several views, a vehicle 20 having an assembly 22 that controls cleaning fluid, e.g., for autonomous operation of the vehicle 20 is shown. The assembly 22 includes an inlet tube 24 and an outlet tube 26. The assembly 22 includes a solenoid assembly 28 having a plunger 30 movable between an open position in which fluid is permitted to flow from the inlet tube 24 to the outlet tube 26 and a closed position in which fluid is inhibited from flowing from the inlet tube 24 to the outlet tube 26. The solenoid assembly 28 has an induction coil 32 surrounding the plunger 30. The assembly 22 includes a Hall effect sensor 34 that detects a magnetic field of the solenoid assembly 28. The assembly 22 includes a computer 36 in communication with the Hall effect sensor 34. The computer 36 has a processor and memory that stores instructions executable by the processor to identify a resistance of the induction coil 32 based on data from the Hall effect sensor 34, and to determine whether the plunger 30 is at the closed position based on the identified resistance of the induction coil 32.

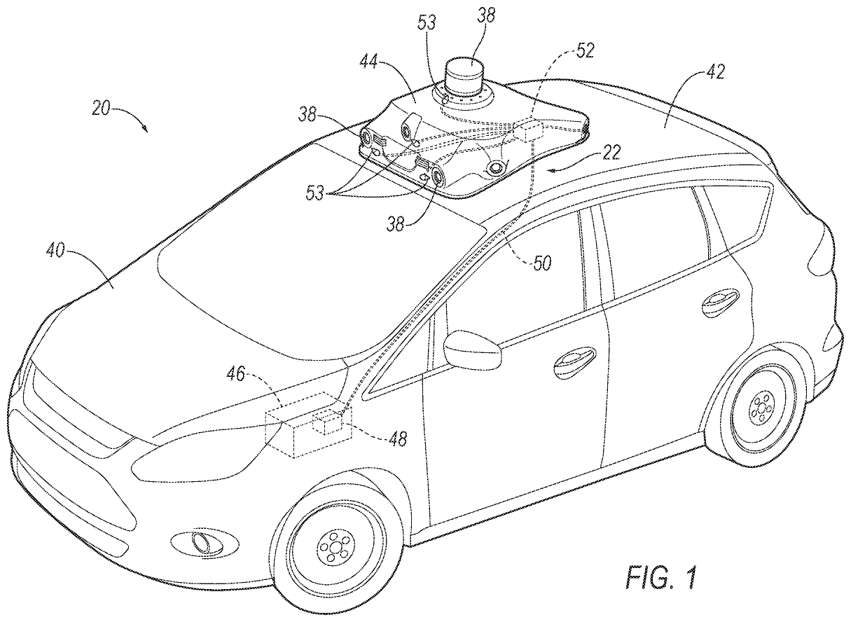

With reference to FIG. 1, the vehicle 20 can be any passenger or commercial automobile such as a car, a truck, a sport utility vehicle, a crossover, a van, a minivan, a taxi, a bus, etc.

The vehicle 20 may be an autonomous vehicle. The computer 36 can be programmed to operate the vehicle 20 independently of the intervention of a human driver, completely or to a lesser degree. The computer 36 may be programmed to operate the propulsion, brake system, steering, and/or other vehicle systems based at least in part on data received from sensors 38. For the purposes of this disclosure, autonomous operation means the computer 36 controls the propulsion, brake system, and steering without input from a human driver; semi-autonomous operation means the computer 36 controls one or two of the propulsion, brake system, and steering and a human driver controls the remainder; and nonautonomous operation means a human driver controls the propulsion, brake system, and steering.

The vehicle 20 includes a body 40. The vehicle 20 may be of a unibody construction, in which a frame and the body 40 of the vehicle 20 are a single component. The vehicle 20 may, alternatively, be of a body-on-frame construction, in which the frame supports the body 40 that is a separate component from the frame. The frame and body 40 may be formed of any suitable material, for example, steel, aluminum, etc.

The body 40 includes body panels partially defining an exterior of the vehicle 20. The body panels may present a class-A surface, e.g., a finished surface exposed to view by a customer and free of unaesthetic blemishes and defects. The body panels include, e.g., a roof 42, etc.

A housing 44 for the sensors 38 is attachable to the vehicle 20, e.g., to one of the body panels of the vehicle 20, e.g., the roof 42. For example, the housing 44 may be shaped to be attachable to the roof 42, e.g., may have a shape matching a contour of the roof 42. The housing 44 may be attached to the roof 42, which can provide the sensors 38 with an unobstructed field of view of an area around the vehicle 20. The housing 44 may be formed of, e.g., plastic or metal.

The sensors 38 may detect the location and/or orientation of the vehicle 20. For example, the sensors 38 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 38 may detect the external world, e.g., objects and/or characteristics of surroundings of the vehicle 20, such as other vehicle, road lane markings, traffic lights and/or signs, pedestrians, etc. For example, the sensors 38 may include radar sensors, scanning laser range finders, light detection and ranging (LIDAR) devices, and image processing sensors such as cameras. The sensors 38 may include communications devices, for example, vehicle-to-infrastructure (V2I) or vehicle-to-vehicle (V2V) devices.

The sensors 38 are disposed within, and/or are mounted to, the housing 44. For example, the sensors 38 can include multiple cameras disposed within the housing 44 and at least one LIDAR device mounted to the housing 44, as shown in FIG. 1.

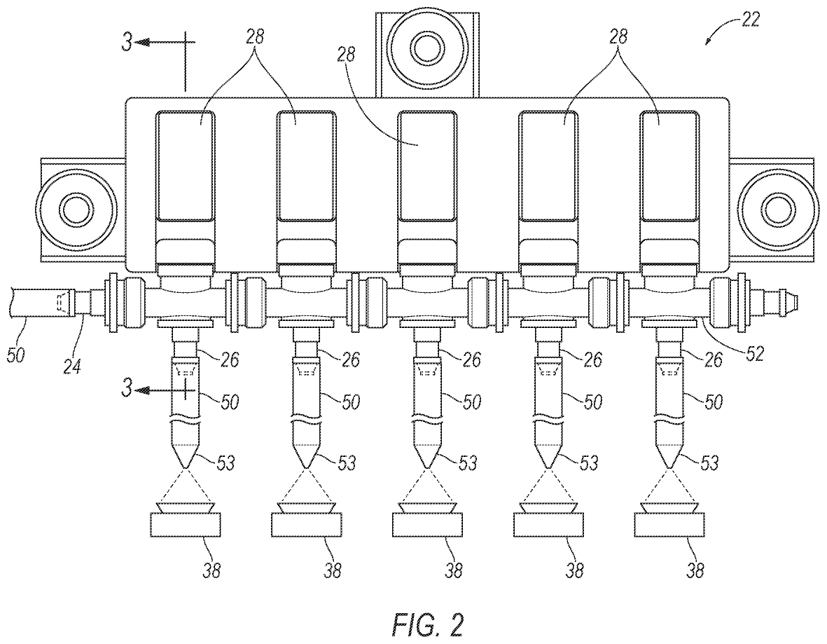

With reference to FIGS. 1 and 2, the assembly 22 may include includes a reservoir 46, a pump 48, supply lines 50, a manifold 52 (which includes the inlet tube 24 and one or more outlet tubes 26), and nozzles 53. The reservoir 46, the pump 48, the manifold 52, and the nozzles 53 are fluidly connected to each other (i.e., fluid can flow from one to the other) via the supply lines 50. The assembly 22 distributes washer fluid stored in the reservoir 46 to the nozzles 53. “Washer fluid” is any liquid stored in the reservoir 46 for cleaning. The washer fluid may include solvents, detergents, diluents such as water, etc. Alternatively or additionally, the assembly 22 could use compressed air routed through the manifold 52 and the supply lines 50 to the nozzles 53.

The reservoir 46 is a tank fillable with liquid, e.g., washer fluid for window cleaning. The reservoir 46 may be disposed in a front of the vehicle 20, specifically, in an engine compartment forward of a passenger cabin. Alternatively, the reservoir 46 may be disposed within the housing 44.

The pump 48 can force the washer fluid through the supply lines 50 and the manifold 52 to the nozzles 53 with sufficient pressure that the washer fluid sprays from the nozzles 53. The pump 48 is fluidly connected to the reservoir 46. The pump 48 may be attached to or disposed in the reservoir 46. The pump 48 is fluidly connected to the manifold 52, specifically to the inlet tube 24 the manifold 52, via one of the supply lines 50.

The manifold 52 includes the inlet tube 24 and one or more outlet tubes 26, which can vary in number. In the example shown in Figures, the manifold 52 includes five outlet tubes 26. The manifold 52 can direct washer fluid entering the inlet tube 24 to any combination of the outlet tubes 26. The manifold 52 can be disposed within, and fixed relative to, the housing 44.

The manifold 52 receives fluid from the reservoir 46 at the inlet tube 24. For example, one of the supply lines 50 may extend from the pump 48 to the inlet tube 24 of the manifold 52. The manifold 52 provides the fluid to one or more nozzles 53 via the outlet tubes 26. For example, the supply lines 50 may extend from the outlet tubes 26 of the manifold 52 to the nozzles 53. The supply lines 50 may be, e.g., flexible tubes.

Each of the nozzles 53 is fluidly connected to one of the outlet tubes 26 via one of the supply lines 50. The nozzles 53 may face the camera or other sensors 38 of the assembly 22. In other words, the nozzles 53 are positioned to eject the washing fluid to clear obstructions from fields of view of the sensors 38, e.g., nozzles 53 may be aimed at the sensors 38 or at windows (not labeled) for the sensors 38. The pressure of the washer fluid exiting the nozzles 53 can dislodge or wash away obstructions that may impede the fields of view of the sensors 38.

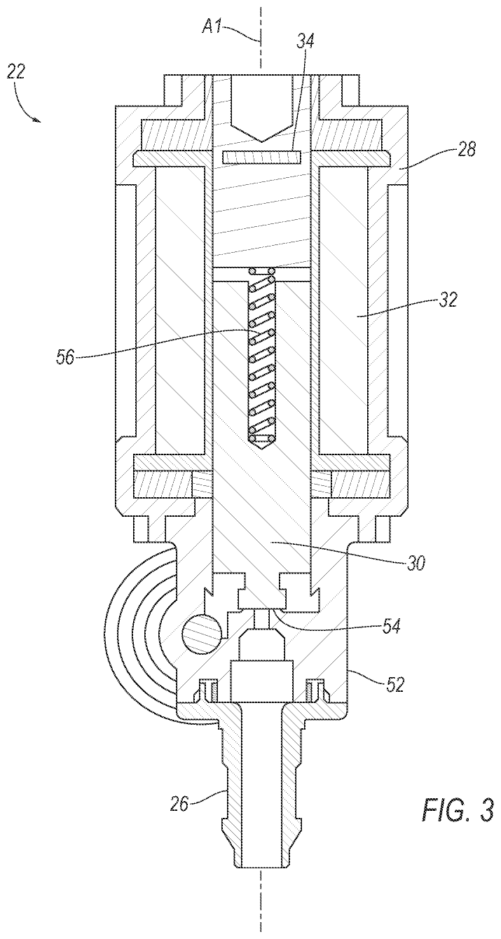

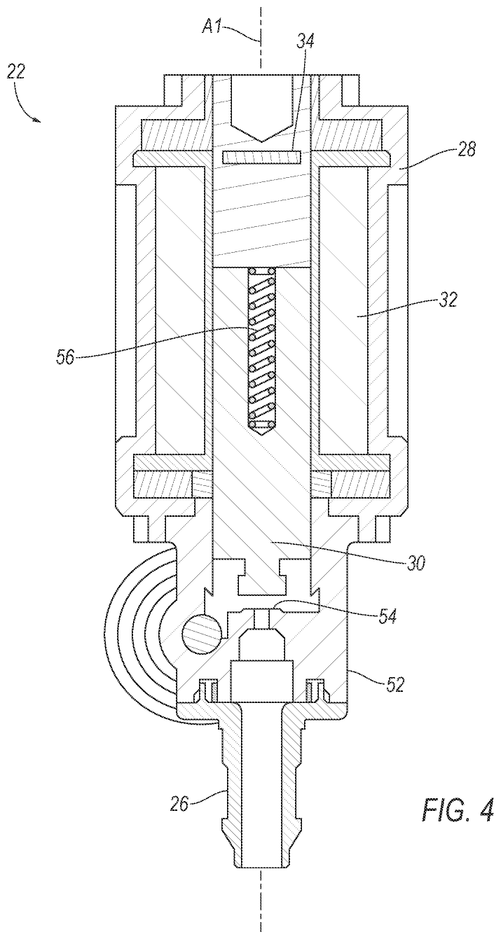

With reference to FIGS. 2-4, the solenoid assembly 28 controls fluid flow from the inlet tube 24 to one of the outlet tubes 26 and the nozzle 53 connected thereto. The solenoid assembly 28 includes the plunger 30. The plunger 30 is movable along an axis A1 between the closed position, shown in FIG. 3, in which fluid is inhibited from flowing from the inlet tube 24 to such outlet tube 26, and the open position, shown in FIG. 4, in which fluid is permitted to flow from the inlet tube 24 to one of the outlet tubes 26. For example, the manifold 52 may include valve seats 54 surrounding each of the outlet tubes 26. The plunger 30 in the closed position may abut the valve seat 54 surrounding one of the outlet tubes 26. The plunger 30 in the open position may be spaced from the valve seat 54 surrounding one of the outlet tubes 26. Fluid may flow through the space between the plunger 30 and the valve seat 54 into such outlet tube 26. The plunger 30 and/or the valve seats 54 may include a rubber coating or other sufficient structure that seals the plunger 30 to the valve seat 54 in the closed position, i.e., such that fluid is inhibited from flowing therebetween.

With reference to FIGS. 3 and 4, the solenoid assembly 28 includes a spring 56. The spring 56 of the solenoid assembly 28 includes a plurality of coils. The spring 56 is elongated between distal ends and along the axis A1. For example, the spring 56 may be a conventional compression coil spring. One of the distal ends of the spring 56 may abut the plunger 30. The spring 56 may be under compression, urging the plunger 30 toward the closed position. For example, internal forces from the spring 56 may urge the plunger 30 toward the valve seat 54.

The induction coil 32 of the solenoid assembly 28 surrounds the plunger 30. The induction coil 32 is actuatable to move the plunger 30 to the open position. The induction coil 32 includes a plurality of windings wound around the plunger 30. The induction coil 32 generates a magnetic field, e.g., in response to a flow of electricity through the windings. The magnetic field may urge the plunger 30 toward the open position. For example, when no electricity is supplied to the windings, force from the spring 56 may maintain the plunger 30 at the closed position. Upon application of electricity to the windings, force from the magnetic field generated by the induction coil 32 may overcome the force of the spring 56 and move the plunger 30 to the open position.

The Hall effect sensor 34 detects the magnetic field generated by the induction coil 32 of the solenoid assembly 28. The Hall effect sensor 34 outputs a voltage that is directly proportional to a strength of the magnetic field detected by the Hall effect sensor 34. The output voltage of the Hall effect sensor 34 is proportional to an electrical current of the induction coil 32. Accordingly, the Hall effect sensor 34 can be utilized for sensing the current of the induction coil 32. The Hall effect sensor 34 may be fixed to a case or other structure of solenoid assembly 28. The Hall effect sensor 34 may be proximate to an end of the plunger 30, e.g., opposite the outlet tube 26. In other words, the plunger 30 may be between the Hall effect sensor 34 and the outlet tube 26 along the axis A1. The plunger 30 may be closer to the Hall effect sensor 34 in the open position than in the closed position along the axis A1.

The assembly 22 may include multiple solenoid assemblies 28 that control fluid flow through the outlet tubes 26 of the manifold 52. The solenoid assemblies 28 may be fixed to the manifold 52, e.g., one of the solenoid assemblies 28 may be at each of the outlet tubes 26. Each of the solenoid assemblies 28 may include the plunger 30, the spring 56, the induction coil 32, and the Hall effect sensor 34, e.g., as described herein. The Hall effect sensor 34 of each solenoid assembly 28 detects a magnetic field generated by the induction coil 32 of such solenoid assembly 28. One of the solenoid assemblies 28 may control fluid flow through one of the outlet tubes 26 to one of the nozzles 53, and another of the solenoid assemblies 28 may control fluid flow through another of the outlet tubes 26 to another of the nozzles 53. In other words, the solenoid assemblies 28 can independently block or open each of the respective outlet tubes 26 by moving plungers 30 of the solenoid assemblies 28.

The computer 36 is a microprocessor-based controller implemented via circuits, chips, or other electronic components. The computer 36 includes a processor and a memory such as are known. The memory includes one or more forms of computer readable media, and stores instructions executable by the computer 36 for performing various operations, including as disclosed herein. The computer 36 may be programmed to execute operations disclosed herein. Specifically, the memory stores instructions executable by the processor to execute the operations disclosed herein and electronically stores data and/or databases. For example, the computer 36 may include one or more dedicated electronic circuit including an ASIC (Application Specific Integrated Circuit) that is manufactured for a particular operation. In another example, the computer 36 may include an FPGA (Field Programmable Gate Array) which is an integrated circuit manufactured to be configurable by a customer. As an example, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, and logical components inside an FPGA may be configured based on VHDL programming, e.g., stored in a memory electrically connected to the FPGA circuit. In some examples, a combination of processor(s), ASIC(s), and/or FPGA circuits may be included inside a chip packaging. The computer 36 may be a set of computers communicating with one another.

The computer 36 is generally arranged for communications on a communication network 58 that can include a bus in the vehicle 20 such as a controller area network (CAN) or the like, and/or other wired and/or wireless mechanisms. Via the communication network 58, the computer 36 may transmit messages to various devices, and/or receive messages (e.g., CAN messages) from the various devices, e.g., the sensors 38, the induction coil 32, the Hall effect sensor 34, etc. Alternatively or additionally, in cases where the computer 36 comprises a plurality of devices, the communication network 58 may be used for communications between devices represented as the computer 36 in this disclosure.

The computer 36 is programmed to, i.e., the memory stores instructions executable by the processor to, actuate the plungers 30 of the respective solenoid assemblies 28, e.g., from the open position to the closed position and vice versa. The computer 36 may actuate the plunger 30 of one of the solenoid assemblies 28 to the open position by transmitting a command to such solenoid assembly 28, e.g., via the communication network 58. The command may, for example, provide a specified voltage to the induction coil 32 of the solenoid assembly 28 and generate a magnetic field that urges the plunger 30 away from the valve seat 54 with sufficient force to overcome the force applied to the plunger 30 by the spring 56. The computer 36 may actuate the plunger 30 to the closed position by transmitting a command to the solenoid assembly 28, e.g., via the communication network 58. The command may, for example, cease providing the specified voltage to the induction coil 32 of the solenoid assembly 28, thereby permitting force from the spring 56 to move the plunger 30 to the closed position in abutment with the valve seat 54. The computer 36 may individually and selectively actuate the solenoid assemblies 28, i.e., actuate one or more of the solenoid assemblies 28, and not others. The computer 36 may individually and selectively actuate the solenoid assemblies 28 to clean selected sensors 38, such as cameras, of the vehicle 20.

The computer 36 is programmed to identify a resistance of the induction coil 32 based on data from the Hall effect sensor 34. The computer 36 identifies the resistance of the induction coil 32 based on a current detected by the Hall effect sensor 34, e.g., using Ohm's Law (R=V/I), where the voltage V is a voltage applied to the induction coil 32 and the current I is the current detected by the Hall effect sensor 34. The computer 36 may detect the current with the data from Hall effect sensor 34 (e.g., the voltage output by the Hall effect sensor 34) with a lookup table, formula, or the like that correlates various output voltages with currents. The lookup table, formula, etc., may be populated via empirical testing. The computer 36 may use other conventional techniques to detect the current based on the output voltage. The computer 36 may identify the voltage applied to the induction coil 32 by specifying such voltage, with one or more sensors 38 configured to detect voltage, e.g., voltmeters, or with other conventional techniques. Different identifiable resistances are produced at different positions of the plunger 30. For example, the plunger 30 at the closed position may provide a higher resistance than the plunger 30 at the open position.

The computer 36 is programmed to determine whether the plunger 30 is at the closed position based on the identified resistance of the induction coil 32. The computer 36 may determine whether the plunger 30 is at the closed position by comparing the identified resistance of the induction coil 32 with a first predetermined amount of resistance. The computer 36 may determine the plunger 30 is at the closed position when the identified resistance is equal to (or greater than) the first predetermined amount of resistance. The first predetermined amount of resistance may be predetermined by empirical testing. The first predetermined amount of resistance may be determined as equal to an identified resistance of the induction coil 32 when the plunger 30 is known to be in the closed position, e.g., when fluid pressure is supplied to the inlet tube 24 and does not flow from the outlet tube 26 closed by the plunger 30. The first predetermined amount of resistance may be stored in memory. The computer 36 may determine the plunger 30 is not at the closed position when the identified resistance of the induction coil 32 is less than the first predetermined amount of resistance. For example, a resistance may be less when dirt or other debris inhibits the spring 56 from fully extending and moving the plunger 30 to the closed position than a resistance when the spring 56 is fully extended with the plunger 30 in the closed position. The computer 36 may individually determine whether the plunger 30 of each of the solenoid assemblies 28 is at the closed position based on data received from the Hall effect sensor 34 of the respective solenoid assembly 28. The computer 36 may determine whether the plunger 30 of one of the solenoid assemblies 28 is at the closed position after the computer 36 actuates such plunger 30 to the closed position, e.g., after the computer 36 has ceased providing voltage to the induction coil 32 of such solenoid assembly 28.

The computer 36 is programmed to store a diagnostic code, e.g., in memory, upon determining the plunger 30 of one of the solenoid assemblies 28 is not at the closed position. The diagnostic code may include data specifying which specific solenoid assembly 28 included the plunger 30 that was determined not to be at the closed position. Additionally and upon determining the plunger 30 of one of the solenoid assemblies 28 is not at the closed position, the computer 36 may transmit an error code to a server computer, and/or transition the vehicle 20 from autonomous operation to nonautonomous operation.

The computer 36 is programmed to determine whether the plunger 30 of each of the solenoid assemblies 28 is at the open position based on data received from the Hall effect sensor 34 of such solenoid assembly 28, e.g., via the communication network 58. The computer 36 may determine whether the plunger 30 is at the open position by comparing the identified resistance with a second predetermined amount of resistance. The computer 36 may determine the plunger 30 is at the open position when the identified resistance is equal to (or less than) the second predetermined amount of resistance. The computer 36 may determine the plunger 30 is not at the open position when the identified resistance is less than the second predetermined amount of resistance. The second predetermined amount may be stored in memory and predetermined by empirical testing, e.g., the second predetermined amount may be equal to a resistance identified when the plunger 30 is known to be in the open position, e.g., when fluid pressure is supplied to the inlet tube 24 and fluid freely flows from the respective outlet tube 26. The computer 36 may individually determine whether the plunger 30 of each of the solenoid assemblies 28 is at the open position based on data received from the Hall effect sensor 34 of the respective solenoid assembly 28. The computer 36 may determine whether the plunger 30 of one of the solenoid assemblies 28 is at the open position after the computer 36 actuates the plunger 30 to the open position, e.g., after the computer 36 has commanded application of a specified voltage to the induction coil 32 of such solenoid assembly 28. The computer 36 may be programmed to, upon determining the plunger 30 of one of the solenoid assemblies 28 is not at the open position, store a diagnostic code, etc.

Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Use of “in response to,” “based on,” and “upon determining” herein indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An assembly, comprising:
an inlet tube;
an outlet tube; and
a solenoid assembly having a plunger movable between an open position in which fluid is permitted to flow from the inlet tube to the outlet tube and a closed position in which fluid is inhibited from flowing from the inlet tube to the outlet tube, the solenoid assembly having an induction coil surrounding the plunger;
a Hall effect sensor that detects a magnetic field of the solenoid assembly; and
a computer in communication with the Hall effect sensor, the computer having a processor and memory that stores instructions executable by the processor to identify a resistance of the induction coil based on data from the Hall effect sensor, and to determine whether the plunger is at the closed position based on the identified resistance of the induction coil.

2. The assembly of claim 1, wherein the instructions include instructions to identify the resistance of the induction coil based on a current detected by the Hall effect sensor.

3. The assembly of claim 1, further comprising a fluid reservoir fluidly connected with the inlet tube.

4. The assembly of claim 3, further comprising a nozzle fluidly connected with the outlet tube.

5. The assembly of claim 4, further comprising a camera, the nozzle facing the camera.

6. The assembly of claim 1, wherein the plunger is movable along an axis, and the plunger is between the Hall effect sensor and the outlet tube along the axis.

7. The assembly of claim 1, further comprising a valve seat between the plunger and the outlet tube.

8. The assembly of claim 7, wherein the plunger in the closed position abuts the valve seat.

9. The assembly of claim 1, wherein the instructions include instructions to store a diagnostic code in memory in response to determining the plunger is not at the closed position.

10. The assembly of claim 1, wherein the solenoid assembly includes a spring urging the plunger toward the closed position.

11. The assembly of claim 1, wherein the plunger is closer to the Hall effect sensor in the open position than in the closed position.

12. An assembly, comprising:
a solenoid assembly having a plunger movable along an axis between a first position and a second position, the solenoid assembly having an induction coil surrounding the plunger;
a Hall effect sensor that detects a magnetic field of the solenoid assembly; and
a computer in communication with the Hall effect sensor and having a processor and memory that stores instructions executable by the processor to identify a resistance of the induction coil based on data from the Hall effect sensor, and to determine whether the plunger is at the second position based on the magnetic field detected by the Hall effect sensor and the identified resistance of the induction coil.

13. The assembly of claim 12, wherein the instructions include instructions to identify the resistance of the induction coil based on a current detected by the Hall effect sensor.

14. The assembly of claim 12, wherein the instructions include instructions to store a diagnostic code in memory in response to determining the plunger is not at the second position.

15. The assembly of claim 12, wherein the solenoid assembly includes a spring urging the plunger toward the closed position.

16. The assembly of claim 12, wherein the plunger is closer to the Hall effect sensor in the open position than in the closed position.
